(19) United States
(12) Patent Application Publication
(10) Pub. No.: US 2003/0200181 A1
(43) Pub. Date: Oct. 23, 2003

(54) Connectionless point-of-sale and code activation system

(76) Inventor: Jan van Kessel, Hudson (CA)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/417,522

(22) Filed: Apr. 17, 2003

Related U.S. Application Data
(60) Provisional application No. 60/374,409, filed on Apr. 22, 2002.

(51) Int. Cl. G06F 17/60

(52) U.S. Cl. 705/73

(57) ABSTRACT

A method and system for utilizing remote code generation terminals to generate authorization codes that control and authorize the activation of a service device. The remote code generation terminals each allow a customer to select between multiple service levels for operation of the remote service device. The code generation terminal generates an authorization code that includes various groups each having a specified number. The groups are encoded into an authorization code, which is then encrypted and printed for the user. The customer enters the encrypted co authorization code into the remote service device that validates the authorization code and begins operation of the service device. A computer controller in the service device keeps track of the used authorization codes in its own internal database such that each authorization code can only be used once.

### CROSS-REFERENCE TO RELATED APPLICATION

The present application is based on and claims priority to U.S. Provisional Patent Application Ser. No. 60/374,409 filed on Apr. 22, 2002.

### BACKGROUND OF THE INVENTION

Traditionally, unattended car washes have been activated using a code that has been generated by a point-of-sale (POS) terminal. The POS terminal generates an activation code to the customer upon receipt of payment and includes information concerning the service level selected by the customer. When a customer desires to activate the wash, they do so by entering their activation code on a keypad by the entrance of the wash. As the activation code is entered, the code is checked with the POS terminal to determine whether the code is valid. Thus the keypad needs to be electrically connected to the POS terminal to verify the code. If the activation code is correct, the POS terminal authorizes the wash service. As shown in FIG. 1, the POS terminal, entrance keypad and car wash must be electrically connected in all the present systems.

The type of system shown in FIG. 1 has several drawbacks in that the POS terminal, the entrance keypad and the car wash must all be connected. Further, the car wash typically is serviced by only one POS terminal that limits the places the car wash services can be purchased.

Therefore, a need exists for a system that allows multiple POS terminals to each generate a unique wash code from a remote location not electronically connected to the car wash. Further, a need exists for a code system that insures that the code entered into the entrance keypad of the car wash is valid and was issued by one of the authorized POS terminals.

### SUMMARY OF THE INVENTION

The present invention is directed to a method of selling authorization codes from a remote code generation terminal, or point-of-sale (POS) terminal, that is not electrically connected to a service device, such as a car wash. When an authorization code is redeemed at the car wash or service device, the validity of the authorization code is verified and the car wash started without an electrical connection to the code generation or POS terminal.

The system the invention functions by encoding information related to the wash process in an authorization code generated for the consumer. Each POS terminal has a unique terminal identification number which forms part of the authorization code. Additionally, each car wash and group of POS terminals has a unique client identification number that allows multiple networks to function in a single geographic region. Each day, the computer operating the entrance keypad for the service device sets a batch of sequence numbers aside for each of the POS terminals. An encoding algorithm is designed in such a way that each of the POS authorization codes are unique.

In each unique authorization code is an encrypted POS terminal identification number (used to signify where the code came from), a wash package identifier based on the wash package purchased (used to start the right wash program), a sequence number for the day (used to allow a code to be used only once at the wash), a day identification number (used to let the code expire if not used), a client identification number (used to make sure codes only work in its own group). For example, in the preferred embodiment of the invention, the authorization code is six digits, which is determined by the maximum of each group number multiplied together to generate the maximum code length.

Once the customer has selected the wash package, the POS terminal generates the authorization code using an encoding process. The authorization code is then encrypted and printed as a receipt for the customer.

Upon receiving the code, the customer takes the code to the remote car wash and enters the code through a keyboard. The car wash and keyboard are not electrically connected to the POS terminal that generated the authorization code.

Upon receiving the code entered by the customer, the code is decrypted. Once decrypted, the code is then broken into its individual group parts that identify the POS terminal, the wash program selected, the day number and the sequence number.

Once the car wash has broken the authorization code down into its component parts, the car computer controller of the wash first verifies the day number the code was generated. If the day number has not expired, the authorization code is compared with a stored database of all possible authorization codes. If the authorization code is valid and unused, the car wash begins operation and the computer controller marks the specific authorization code as being used. Thus, the same authorization code cannot be used again once the car wash has marked it as used.

In a further embodiment of the invention, the car wash includes a window that allows only a certain number of authorization codes to be active at a given time. Typically, the window width is around twenty such that when an authorization code is received at the car wash, the window width is added to the specific sequence number such that an additional number of sequences can be authorized. In this manner, the window width controls the number of possible sequence numbers that can be valid at any given time, thereby increasing the security of the system.

Various other features, objects and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 is a block diagram illustrating a conventional code entry and verification system of the prior art;

FIG. 2 is a block diagram illustrating the first embodiment of the invention in which a single point-of-sale terminal is separate from the entrance keypad and car wash;

FIG. 3 is illustrates a second embodiment of the invention in which multiple, remote point-of-sale terminals are used to service a single car wash having an entrance keypad;

FIG. 4 is an illustration of the configuration screen for each point-of-sale terminal;

FIG. 5 is a schematic illustration showing the method used to generate a unique authorization code at one of the remote point-of-sale terminals and the validation of the authorization code at the car wash; and

FIG. 6 is a schematic diagram similar to FIG. 5 illustrating the use of a moving window to enhance the generation and validation of the authorization code being generated by the remote point-of-sale terminal.

### DETAILED DESCRIPTION OF THE INVENTION

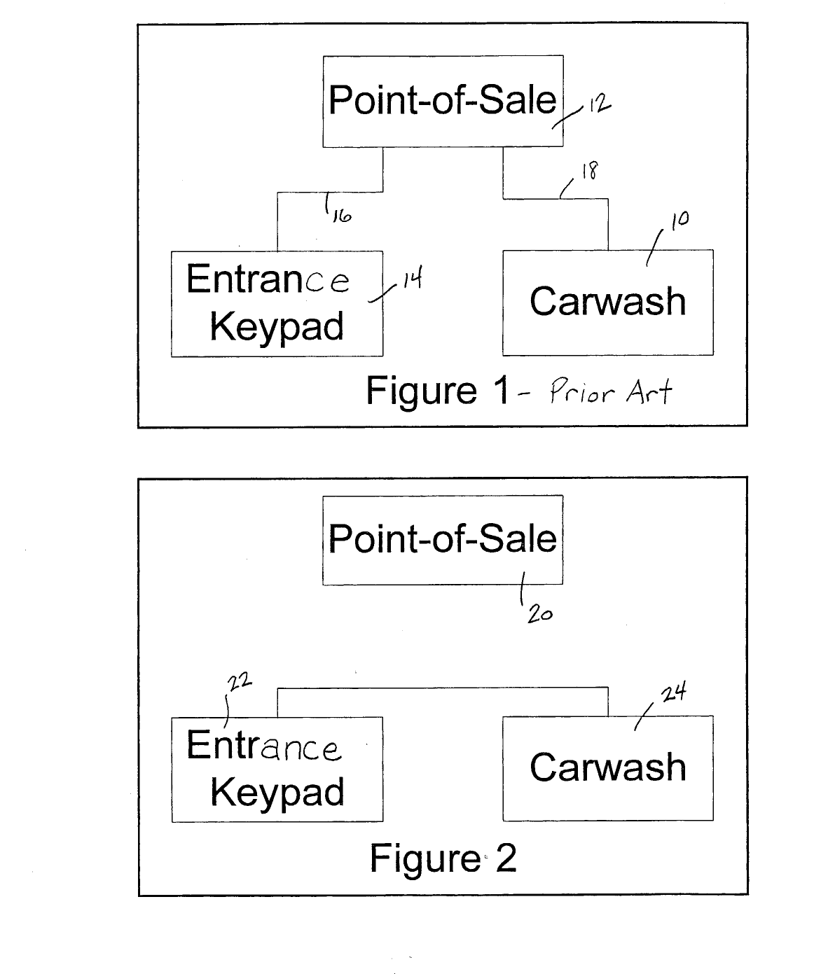

As described previously, in prior art car wash systems, the car wash 10 is electrically connected to a point-of-sale (POS) terminal 12, as illustrated in FIG. 1. The POS terminal 12 is also connected to an entrance keypad 14. The POS terminal 12 generates an authorization code upon payment by a customer. The authorization code generated by the POS terminal 12 includes information relating to the service package selected by the customer. Typically, the car wash 10 allows the customer to purchase different levels of service for such things as an underbody wash, wax or other service level. Thus, the authorization code generated by the POS terminal 12 must include information relating to the level of service selected.

Once the customer receives the authorization code, the authorization code is entered by the entrance keypad 14. Upon entry of the authorization code, the code is transmitted back to the POS terminal 12 which performs a validity check to determine whether the code is valid. The communication between the entrance keypad 14 and the point-of-sale terminal is over a hardwire connection 16, as illustrated.

If the authorization code is validated by the POS terminal 12, the POS terminal 12 relays information relating to the service package to the car wash 10 through another hardwire connection 18. Upon receiving this information, the car wash 10 begins operation in a normal manner.

In the standard installation shown in FIG. 1, the car wash 10 and the POS terminal 12 are in close proximity due to the hardwire connections 16 and 18. For example, the POS terminal may be located in a gas station that is on the same property as the car wash 10. In addition to the physical proximity limitations, the installation cost of such a system includes the cost to electrically connect the POS terminal 12 to both the car wash 10 and the entrance keypad 14.

FIG. 2 illustrates the improved connectionless point-of-sale and code activation system of the present invention. As illustrated, the POS terminal 20 is isolated from both the entrance keypad 22 and the car wash 24. In accordance with the present invention, the POS terminal 20 generates an authorization code to a customer who can enter the authorization code into the car wash 24 through the entrance keypad 22. By utilizing the method of the present invention, the entrance keypad 22 and car wash 24 can verify and validate the authorization code without communicating back to the POS terminal 20. In this manner, the POS terminal 20 can be located remotely from the car wash 24. Thus, the installation cost of the system shown in FIG. 2 can be reduced due to the elimination of the electrical connections between the POS terminal 20 and both the entrance keypad 22 and the car wash 24.

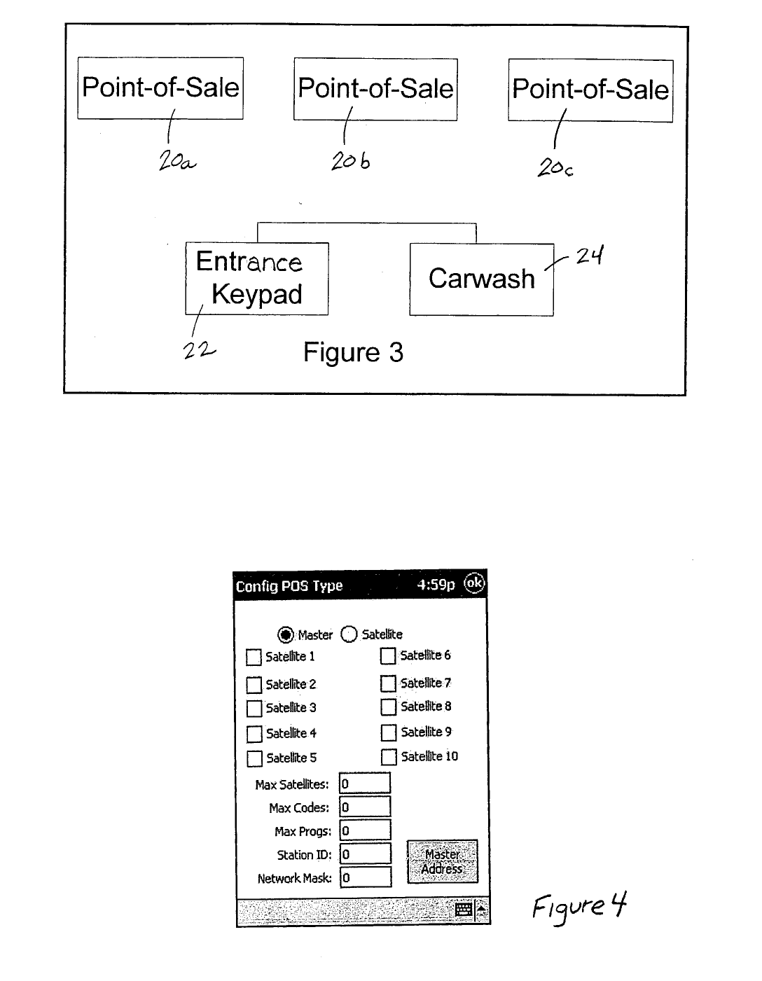

Referring now to FIG. 3, thereshown is an alternate, preferred configuration of the system of the present invention. The system illustrated in FIG. 3 includes multiple POS terminals 20a, 20b and 20c. The multiple POS terminals 20a-20c are each capable of generating an authorization code to activate the car wash 24. The authorization codes are again entered through the entrance keypad 22. It is contemplated that the system shown in FIG. 3 allows for multiple locations near the car wash 24 to sell authorization codes that can be used at the single car wash 24. For example, the neighborhood grocery store, video store and gas station could all sell authorization codes for the single local car wash 24. The remote POS terminals 20a-20c do not need to be connected to each other or to the car wash 24.

Referring now to FIG. 5, thereshown is the method of operation for the system of the present invention. The system of the present invention works by encoding information into an authorization code number generated to the consumer. As will be described in much greater detail below, each POS terminal includes a unique terminal identification number while each car wash also includes its own unique client identification number. The client identification number for the car wash allows multiple networks operating in accordance with the present invention to be used concurrently within a single geographic region.

Initially, a customer approaches the remote POS terminal 20 and is prompted to select a level of service for the operation of the car wash 24. Typically, the POS terminal 20 allows the customers to select from multiple service levels including different service options such as the application of wax, an underbody flush and wheel cleaning. In the embodiment of the invention illustrated, the user is able to select up to nine different wash packages, although different numbers of wash packages can be selected.

Once the customer has selected a service level, the computer controller of the point-of-sale terminal 20 generates an encoded authorization code, as illustrated in step 26. In the embodiment of the invention illustrated, the authorization code generated at step 26 is created using four separate segments or groups. The first group, G1, consists of a station ID number, as illustrated by block 28. In the embodiment of the invention illustrated, the station ID number can be any integer in the range of 1-9. The station ID number in the illustrated embodiment allows up to nine unique POS terminals 20 to generate authorization codes for the single car wash 24.

The second group, G2, includes the different service levels, or wash programs, that can be selected for operation of the car wash 24, as shown by block 30. In the embodiment of the invention illustrated, the wash program can be again selected from the numbers 1-4, such that the car wash 24 can offer four different service levels.

The next group, G3, is used by the POS terminal 20 to indicate on which day the authorization code is being generated, as illustrated by block 32. The day number illustrated by block 32 is in the range of 1-138, the significance of which will be set forth below. Although group G3 is specified as being a day number, it should be understood that group G3 actually refers to a user-specified generation interval that may have a duration greater than or less than one day.

The final group, G4, is used to set the sequence number for the authorization code, as illustrated by block 34. The sequence number illustrated by block 34 sequentially increases as the POS terminal 20 generates authorization codes throughout the day. In accordance with the present invention, the sequence number is reset after the expiration of the generation interval, which is each new day in the preferred embodiment of the invention. In the present invention, the sequence number is in the range of 1-200, although other ranges are clearly contemplated. Thus, each POS terminal 20 is able to generate 200 activation codes each day. Although 200 has been selected in the present invention, it should be understood that the number of sequence numbers can vary depending upon the particular application.

Once the terminal identification number, service level, day number and sequence number have been determined by the POS terminal 20, these four groups are combined using an encoding process in step 26 to generate an activation code. The encoding process carried out in step 26 can be done in many different ways, and the preferred embodiment of the invention will be set forth below.

In accordance with the invention, the encoding system follows the following formula:

Encode=(G1*1)+(G2*G1ₘₐₓ)+(G3*G1ₘₐₓ*G2ₘₐₓ)+(G4*G1ₘₐₓ*G2ₘₐₓ*G3ₘₐₓ) Equation 1

In the encoding formula set forth above, the values G1ₘₐₓ, G2ₘₐₓ and G3ₘₐₓ define the maximum limit for the groups G1 (terminal ID numbers), G2 (service level) and G3 (day number). Thus, in the embodiment of the invention set forth above, G1ₘₐₓ is 9, G2ₘₐₓ is 4 and G3ₘₐₓ is 138. The encoding process set forth above generates an authorization code having a maximum value of (G1ₘₐₓ)*(G2ₘₐₓ)*(G3ₘₐₓ)*(G4ₘₐₓ). In the embodiment of the invention illustrated, the length of the authorization code was selected to be six digits. Since the maximum values for G1, G2 and G4 are pre-selected, the maximum value for the day number, G3, is selected as high as possible to increase the number of codes.

As an example, if the customer approaches POS terminal 20 having an ID number 4 (G1) selects wash package 2 (G2) on the fifth (5) day of the month (G3) and the POS terminal generates its fifteenth (15) authorization code of the day, the encoded authorization code will be as follows:

Encode=(4*1)+(2*9)+(5*9*4)+(15*9*4*138)=74722 Equation 2

Referring back to FIG. 5, once the authorization code has been generated in step 26, the authorization code is combined with a car wash client identifier 36. The car wash identifier adds additional information to the authorization code relating to the car wash 24 that can be operated by the POS terminal 20. The car wash client identifier 36 allows multiple networks to be operated within a single geographic location.

Once the authorization code has been created, the authorization code is scrambled in step 38. Preferably, the authorization code is encrypted using known encryption methods, such that the authorization code generated in step 26 cannot be determined by a customer without purchasing the authorization code. Preferably, the encryption process in step 38 is a secure method utilizing one of numerous known encryption standards.

Once the authorization code has been encrypted in step 36, the encrypted code is printed in step 40. The printed, scrambled authorization code is then taken by the consumer 42 to the car wash 24. As illustrated, the consumer 42 enters the code in step 44 through a conventional keyboard. After the scrambled authorization code has been entered, the computer controller for the car wash 24 checks the car wash client identifier number in step 46 to determine whether the authorization code can be utilized on the car wash 24. If the code can be utilized on the car wash 24, the computer controller for the car wash 24 unscrambles the authorization code in step 48. The decryption process in step 48 is again a conventional step utilizing known encryption software.

Once the authorization code has been decrypted, the authorization code is decoded in step 50. The decoding process shown in step 50 is the inverse of the encoding process described above and breaks the six-digit authorization code into its respective group numbers as illustrated.

Utilizing the example set forth above, the activation code of 74722 is received after the descrambling process in step 48. In order to determine the value of G4, the integer of 74722 is divided by (G1max*G2max*G3max) which is equal to 15 remainder 202). The integer 15 represents the value of G4.

Next, to determine the value of G3, the decoding process continues with the remainder of 202 which is divided by (G1max*G2max), resulting in 202 divided by 81, which equals 5 with a remainder of 22. Thus, the decomposed value of G3 is 5.

Next, to determine the value of G2, the remainder of 22 is divided by G1max which equals 22 divided by 9 resulting in 2 with a remainder of 4. The integer 2 represents the value of G2, while the remainder 4 is the value of G1. As the above indicates, the decomposition of the authorization code results in the station ID (G1) being 4, the wash program (G2) being 2, the day number (G3) being 5 and the sequence number (G4) being 15, as was set in steps 28-34. The decomposed values for the authorization code are then set in steps 52-58.

Once the values for the terminal identification number 52, wash service level 54, day number 56 and sequence number 58 are determined, the computer controller in the car wash 24 checks a stored database that includes all possible combinations for the four group numbers. Initially, all of the possible authorization codes are indicated as being valid in accordance with the embodiment of the invention illustrated in FIG. 5.

If the computer controller of the car wash 24 determines that the authorization code including the four group numbers is a valid code and currently unused, the car wash 24 will begin the wash process to provide the service level requested. Once the car wash has been activated, the computer controller for the car wash 24 marks the authorization code in the database as being used. Once the authorization code has been marked as used, if the customer attempts to use the authorization code again, the computer controller of the car wash 24 will prevent such operation.

In addition to marking the particular authorization code as used, the computer controller of the car wash 24 will also mark all authorization codes having the same terminal identification number, day number and sequence number as being used, regardless of the service level. In this manner, the computer controller for the car wash will prevent unauthorized operation of the car wash for different service levels.

As can be understood by the above description, the generation of an authorization code including multiple group digits and the decompression of such authorization code at a remote location allows the POS terminal 20 to be located remotely from the car wash without any electrical connection therebetween. Further, the system of the present invention allows multiple POS terminals 20 to generate authorization codes for a single car wash 24 without physical connections between the POS terminal 20 and the car wash 24.

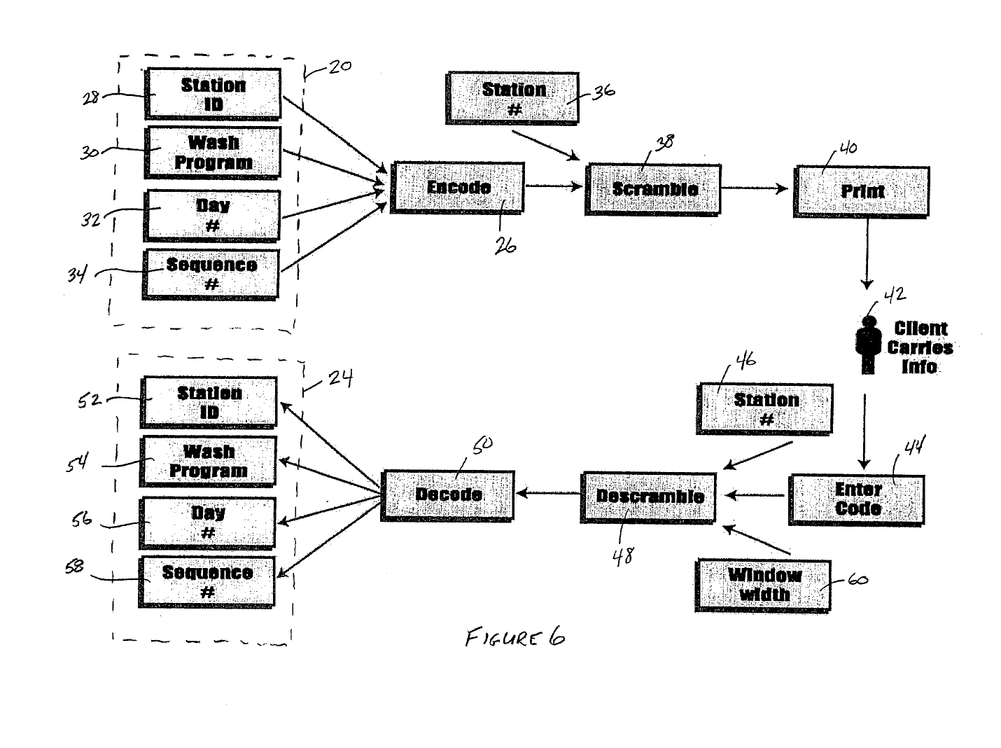

Referring now to FIG. 6, thereshown is an alternate embodiment for the system of the present invention. The embodiment of the invention shown in FIG. 6 creates and generates the authorization codes in the same manner as the embodiment shown in FIG. 5. However, in the embodiment shown in FIG. 6, a window width selector 60 is used during the descramble and decoding process. The window width is used to reduce the number of codes that can be valid at any time. Specifically, the window width is selected at a value, such as 20, such that when an authorization code is received at the car wash, the window width is used to determine whether or not the sequence number is valid. For example, at the start of a new day, the car wash will allow only the first 20 sequence numbers to be valid and thus begin operation of the car wash. As the authorization codes are received at the car wash, the window width allows the car wash to allow activation for any sequence number within 20 of the highest sequence number previously received. Thus, if the car wash receives authorization codes out of sequence, such as receiving sequence number 10 before sequence number 5, the car wash will add the window width to the highest received sequence number and thus allow sequence numbers up to 30 to be authorized.

The use of the window width further enhances the security of the system of the present invention since a smaller number of sequence numbers can be valid at any given time. The size of the window width can be changed depending upon the number of authorization codes being generated by any of the POS terminals 20.

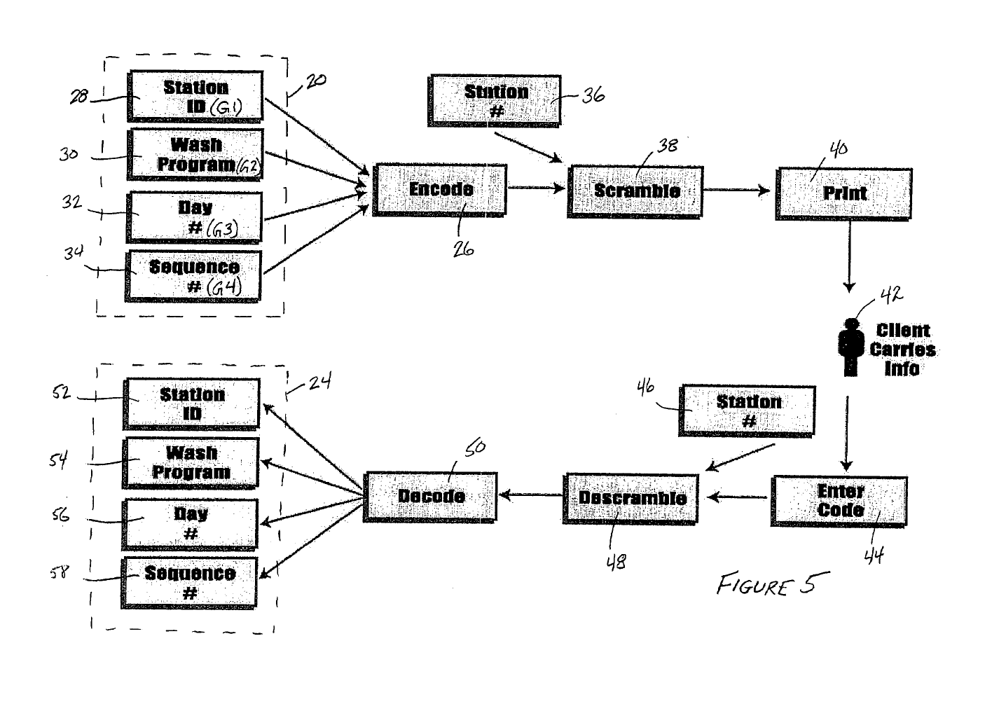

FIG. 4 illustrates a POS configuration screen that allows an owner to configure the remote POS terminal and enter the required information for the remote POS terminal. As illustrated, the possibility of ten stations can be configured using the system illustrated. If the site where the wash code is installed is a master station, the button next to the master will be selected.

If the site where the wash code is installed is a satellite station, the button next to the satellite will be selected. One of the ten possible satellite boxes will then be checked. Additionally, the maximum number of satellites is entered and additional information is added, such as the maximum number of codes being generated each day.

As discussed above, the parameters configured in the screen shown in FIG. 4 are used in the encoding formula to generate the authorization code, which is then printed using an encryption method.

As described above, the benefits of the system of the present invention are that the system does not require wiring between the POS terminals and the car wash, which reduces the installation cost for a typical system and allows the possibility of multiple POS terminals and new POS terminals to be added to the network at any time. The system of the present invention reduces the complications of connecting the POS terminal to the car wash and creates many new, otherwise non-typical sites to purchase a wash package.

Although the present invention has been described as used for a car wash, the present idea can also be applied to various service devices, such as managing parking lots, valet parking, getting controlled access to remote areas (campgrounds, etc.). Additionally, the present invention can also give access to equipment (gas pumps, etc.) using a remote dispatch office that can give out unique codes that are then validated by the remote service device. Additionally, although the present invention has been described as utilizing a POS terminal to generate the authorization code, it should be understood that various different code generation terminals can function within the scope of the present invention. These code generation terminals can be any type of terminal that allows a customer to enter a payment such that the code generation terminal creates a unique authorization code that can be entered at a remote service device. Such code generation terminals could be a gas pump, remote kiosk, ATM machine or any similar type device.

Various alternatives and embodiments are contemplated as being within the scope of the following claims particularly pointing out and distinctly claiming the subject matter regarded as the invention.

I claim:

1. A method of generating an authorization code from a code generation terminal for authorizing the activation of a service device, wherein the code generation terminal is not in direct communication with the service device, the method comprising the steps of:
assigning a terminal identification number to the code generation terminal at which the authorization code is generated;
assigning a sequence number based upon the number of authorization codes generated by the code generation terminal during a generation interval;
combining the terminal identification number and sequence number to create the authorization code;
generating the authorization code to the consumer;
receiving the authorization code at the remote service device;
decomposing the authorization code at the remote service device to determine the terminal identification number and sequence number;
checking the decomposed authorization code with a stored list of authorization codes to determine whether the authorization code is valid; and
activating the service device if the authorization code is valid.

2. The method of claim 1 further comprising the steps of:
encrypting the authorization code prior to generating the authorization code to the consumer; and
decrypting the authorization code at the remote service device.

3. The method of claim 1 wherein the sequence number is sequentially increased after each authorization code is generated.

4. The method of claim 1 further comprising the step of resetting the sequence number at the expiration of the generation interval.

5. The method of claim 4 wherein the generation interval is one day.

6. The method of claim 1 further comprising the step of allowing a customer to select a level of service from a plurality of service levels, wherein the service level number is combined with the terminal identification number and sequence number to create the authorization code.

7. The method of claim 6 wherein the authorization codes are disabled for every service level for the sequence number and terminal identification number upon receipt of the authorization code for the sequence number and terminal identification number.

8. The method of claim 1 wherein a plurality of different terminal identification numbers are assigned such that multiple code generation terminals can provide authorization codes for a single service device.

9. The method of claim 1 further comprising the step of marking the authorization code as used in the service device after activating the service device upon receipt of the valid authorization code such that the authorization code will no longer be valid.

10. The method of claim 1 further comprising the steps of:
assigning a window width value for authorizing only a selected number of sequence numbers for the generation interval;
setting a maximum sequence number for the generation interval;
comparing the sequence number of the received authorization code to the maximum sequence number and authorizing the operation of the car wash only when the current sequence number is less than the maximum sequence number; and
increasing the maximum sequence number to be the sum of the highest valid sequence number received and the window width.

11. The method of claim 1 further comprising the steps of:
assigning a client identification number in combination with the authorization code, the client identification number identifying the service device; and
checking the client identification number received from the customer with the authorized client identification number stored at the service device to determine whether the authorization code is valid for the service device.

12. A method of generating an authorization code from multiple code generation terminals for authorizing the activation of a service device, wherein the code generation terminals are not in direct communication with the service device, the method comprising the steps of:
assigning a terminal identification number based on the code generation terminal at which the authorization code is generated;
assigning a day number based upon the day during which the authorization code is generated;
assigning a sequence number based upon the number of authorization codes generated by the code generation terminal on the current day;
combining the terminal identification number, day number and sequence number to create the authorization code;
generating the authorization code to the consumer;
receiving the authorization code at the remote service device;
decomposing the authorization code at the remote service device to determine the terminal identification number, day number and sequence number;
checking the decomposed authorization code with a stored list of authorization codes to determine whether the authorization code is valid and unused;
activating the service device if the authorization code is valid and unused; and
marking the authorization code as used in the service device such that the authorization code will no longer be valid.

13. The method of claim 12 further comprising the steps of:
encrypting the authorization code prior to generating the authorization code to the consumer; and
decrypting the authorization code at the remote service device.

14. The method of claim 12 wherein the sequence number is sequentially increased after each authorization code is generated.

15. The method of claim 14 further comprising the step of resetting the sequence number each day.

16. The method of claim 12 further comprising the step of allowing a customer to select a level of service from a plurality of service levels, wherein the service level number is combined with the terminal identification number, day number and sequence number to create the authorization code.

17. The method of claim 16 wherein the authorization codes are disabled for every service level for the day number, sequence number and terminal identification number upon receipt of the authorization code for the day number, sequence number and terminal identification number.

18. A method of generating authorization codes from multiple point-of-sale (POS) terminals for authorizing the activation of a car wash, wherein the POS terminals are not in communication with the car wash, the method comprising the steps of:
allowing a customer to select a level of service from a plurality of service levels;
creating the authorization code at the POS terminal, the authorization code including a service number based on the selected service level, a terminal identification number unique to the POS terminal generating the authorization code, a day number based upon the current day and a sequence number identifying the current authorization code generated by the POS terminal for the current day;
generating the authorization code to the customer;
receiving the authorization code at the car wash;
checking the authorization with a stored list of authorization codes in a stored database stored at the car wash to determine whether the authorization code is valid and unused;
activating the car wash to provide the selected level of service if the authorization code is valid and unused; and
marking the authorization code as used in the car wash after providing the level of service.

19. The method of claim 18 further comprising the steps of:
encrypting the authorization code prior to generating the authorization code to the customer; and
decrypting the authorization code at the car wash location prior to checking the authorization code with the stored list of authorization codes.

20. The method of claim 18 wherein the authorization code for every service level is marked as used for all of the service levels upon receipt of the authorization code for the day number, sequence number and terminal identification number.

21. The method of claim 18 further comprising the steps of:
assigning a window width value for authorizing only a selected number of sequence numbers for the current day;
setting a maximum sequence number for the current day;
comparing the sequence number of the received authorization code to the maximum sequence number and authorizing the operation of the car wash only when the current sequence number is less than the maximum sequence number; and
increasing the maximum sequence number to be the sum of the highest valid sequence number received and the window width.

22. The method of claim 18 wherein the sequence number is sequentially increased after each authorization code is generated by the POS terminal.

23. The method of claim 22 further comprising the step of resetting the sequence number at the beginning of each new day.

24. The method of claim 18 further comprising the steps of:
assigning a client identification number in combination with the authorization code, the client identification number identifying the car wash; and
checking the client identification number received from the customer with the authorized client identification number stored at the car wash to determine whether the authorization code is valid for the car wash.
